(19) United States
(12) Patent Application Publication
(10) Pub. No.: US 2004/0139229 A1
(43) Pub. Date: Jul. 15, 2004

(54) Method for outputting content from the internet or an intranet

(76) Inventor: Carsten Mickeleit, Berlin (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 10/472,655

(22) PCT Filed: Jul. 7, 2002
(86) PCT No.: PCT/DE02/02491

(30) Foreign Application Priority Data
Jul. 16, 2001 (DE) 101 33 781.7

(51) Int. Cl. G06F 13/12; H04L 29/08; H04Q 7/22; H04L 12/28

(52) U.S. Cl. 709/245; 709/246

(57) ABSTRACT

The invention relates to a method for directly or indirectly outputting content from the internet, intranet or other such storage media on a terminal so that the address of the content which is to be displayed is transmitted from a first terminal to a second terminal, said content is charged by calling-up the application belonging thereto, subsequently, a print job is initiated by the second terminal for printing out the content and/or constructing a bitmap-data file which is (are) transmitted to the first terminal. Said print job is represented on the display as a print preview on the visible side of the first terminal and/or is transmitted via an interface to a printer for copying and/or the bitmap-data file is represented on the display of the first terminal.

The invention relates to a method for directly or indirectly outputting content from the internet, an intranet, or other such storage medium, to an end device.

In the past, the internet has been accessed predominantly over stationary end devices, i.e., a personal computer or its correlative, so that no limits were set on displaying contents, e.g., documents, image files, etc., which were downloaded from the internet, because these end devices are furnished with sufficiently large screens, complex operating systems that allow execution of a multitude of applications, and high memory capacities which allow storage of multiple applications and processing of large files.

Meanwhile in the framework of technical development, the internet is increasingly accessed over mobile devices such as, for example, mobile telephones, handheld computers, laptop and pocket PCs. In contrast to stationary devices, these mobile end devices are marked by very small display screens, minimal operating systems (Windows CE, Palm, EPOC/Symbian, etc.), minimal application versions suited to minimal operating systems, low working memories which only allow processing of, small files, and low memory capacities which enable only the provision of a selection of applications.

Thus not all content can be displayed intelligently or cannot be displayed at all. For this reason, besides the internet standard HTML, the WAP standard with its WML language was developed. Because of the WAP standard a limited form of internet access is possible using mobile devices. HTML and WML, however, can only communicate documents which were created in these languages to the mobile end device.

As solution to this problem it is attempted to convert relevant files in minimal format, with the purpose of displaying these on the mobile end device. This conversion is made manually and offline, however, so that use is extremely limited.

Nonetheless also stationary end devices are not always capable of displaying relevant contents in an appropriate manner if the necessary application is not installed on them for interpreting the data, insufficient working memory is available for loading the data, or an operating system is available which does not allow the application to be executed, e.g., a Windows application on Unix.

Mobile communications technology has asserted itself with the standard GMS and will continue to be developed with the standards GPRS and HSCSD as well as the future UMTS. Thus the possibilities for transmission are continually optimized; i.e., the transmittable data amount increases drastically, but the possibilities for issuing the content remain limited.

In the same way, displaying content from the internet, an intranet, or other memory medium which can be accessed from such end devices, is limited.

It is therefore the task of the invention to create a method for outputting any content from the internet, an intranet, or other memory medium.

This task is solved by a method with the features in claim 1.

To do so, according to the invention a method is provided for direct or indirect output of contents from the internet, an intranet, or other storage medium on an end device, in which the address of the content which is to be displayed is sent from the end device to a second end device which loads this content under execution of the associated application. Afterwards, a print job is initiated with the second end device for printing the content; this print job is sent to the first end device. The print job is displayed as page view in the display of the first end device and/or sent over an interface to a printer for printout.

“Contents” as used in this context means files and data which can be visualized and printed using application programs. These contents could be found in the internet, an intranet—i.e., a corporate network environment—or other memory media—e.g., central server or individual office computer.

A content's address is usually a so-called URL (Unified Resource Locator; e.g., http://www.thinprint.com/content.doc) or an unambiguous path entry (C:\Documents\content.doc) or an unambiguous label (customer information with the customer number 1234). All of these forms of address can also be offered to the end device user in processed form.

The first end device is preferably a mobile end device such as a mobile telephone, handheld computer, laptop or pocket PC or similar. It could also be a stationary device, however, such as computers which, as described above, are also not suitable for display.

The second end device is usually a high-capacity stationary computer or its correlate. It is also feasible, though, mobile end devices are used, provided they are appropriately furnished.

The interface could be common cable interfaces, infrared or Bluetooth interfaces, or similar.

The address of the content to be displayed is sent to the second end device preferably using a dial-up connection or the internet, whereby the second end device can be a computer in the user's home or office, a corporate server or a server of the internet service provider who offers this server.

If the first end device or a mobile end device is not capable of displaying the print job onscreen, the method provides that a bitmap file is created at the same time from the second end device, which is sent in addition to or instead of the print job to the first end device, because bitmap files can usually be issued on every end device with graphic display capabilities.

To keep the data to be transmitted from the second to the first end device as small as possible, the mobile end device or the first end device transmits its display information, e.g., display size, necessary scaling, color or black-and-white display, to the second end device. This creates a bitmap file from the document which meets the specific requirements, so that only the actually necessary data amount is transmitted.

Further developments of the invention are characterized in the sub claims.

1. Method for directly or indirectly outputting of content from the internet, an intranet, or other storage medium, to an end device,
characterized in
that the address of the content to be displayed is transmitted from a first end device to a second end device,
which loads this content by executing the relevant application; that lastly a print job for printout of the content and/or creation of a bitmap file is/are initiated with the second end device and is/are transmitted to the first end device; and that the print job is displayed on the first end device as page preview and/or sent over an interface to a printer for printout and/or the bitmap file is displayed on the first end device's screen.

2. Method as in claim 1, characterized in that the first end device is a mobile end device.

3. Method as in claim 2, characterized in that the mobile end device is a mobile telephone, handheld computer, laptop or pocket PC.

4. Method as in claim 1, characterized in that the first end device is a stationary end device.

5. Method as in claims 1 to 4, characterized in that the second end device is a mobile end device.

6. Method as in claim 5, characterized in that the mobile end device is a mobile telephone, handheld computer, laptop or pocket PC.

7. Method as in claims 1 to 6, characterized in that the interface is a cable interface or an infrared or Bluetooth interface.

8. Method as in claims 1 to 7, characterized in that the address of the content to be displayed is transmitted over a dial-up connection or the internet.

9. Method as in claims 1 to 8, characterized in that the first end device sends display information with the address to the second end device, which creates from the document a bitmap file that suffices the first end device's specific display requirements.

10. Method as in claim 9, characterized in that the display information includes the display size, the necessary scaling, and/or the input about color or black-and-white display.
